(19) United States
(12) Patent Application Publication
(10) Pub. No.: US 2010/0183815 A1
(43) Pub. Date: Jul. 22, 2010

(54) METHOD AND DEVICE FOR APPLYING LIQUID PAINT TO AN APPLICATION SURFACE

(76) Inventors: Klaus Marx, Stuttgart (DE); Thilo Koeder, Gerlingen (DE); Klaus Dieterich, Stuttgart (DE)

Correspondence Address: MICHAEL J. STRIKER, 103 EAST NECK ROAD, HUNTINGTON, NY, 11743, US

(21) Appl. No.: 12/377,633

(22) PCT Filed: Mar. 3, 2008
(86) PCT No.: PCT/EP08/52558

§ 371 Date: Feb. 16, 2009

(30) Foreign Application Priority Data
Apr. 30, 2007 (DE) 102007020287.5

(51) Int. Cl. B05D 1/02

(52) U.S. Cl. 427/421.1

(57) ABSTRACT

The invention relates to a device for applying liquid paint to an application surface, particularly for applying dispersion paint onto a wall surface, wherein a method is implemented in which the paint is shot drop-wise onto the application surface, and a paint film is formed by the drops flowing into each other on the application surface.

The present invention relates to a method for applying liquid paint to an application surface, in particular for applying dispersion paint onto walls, and to a device for carrying out the method.

### BACKGROUND INFORMATION

The application of paint, in particular viscous dispersion paint onto walls, is carried out by professionals and do-it-yourselfers using paint rollers, spraying systems, brushes, or sponge systems. Laborious preparation is required, regardless of which of these systems is used. This involves, above all, taping edges for the paint application, e.g. onto door frames, and covering all other objects and areas, such as furniture and the floor, as a safeguard against paint flecks. It is difficult in particular to stay within paint application boundaries when the aim is to apply different colors in special shapes or in adjacent areas.

### DISCLOSURE OF THE INVENTION

The object of the present invention is to provide a method and a related device, i.e. a system, with which an opaque, even paint application may be attained on a regular basis without stray flecks and within the specified contours, thereby making it possible to largely eliminate laborious taping and covering work.

This is attained using a method as recited in claim 1, in particular by using a device as recited in claim 5.

According to the method, the application surface is bombarded with paint droplets in a cyclic manner—preferably with a clock frequency in the magnitude of approximately 100 shots/second—and, in fact, in a manner such that the paint strikes the application surface in droplet form, the droplets then flowing into one another and forming an opaque paint film. In the method according to the present invention, the application surface is therefore covered with the droplets quasi in the manner of a carpet, the droplets spreading across the application surface, quasi spilling out along the application surface and flowing into one another, thereby forming a closed, uniform paint film. Paint losses are eliminated, since only that quantity of paint is used that is required for the bombardment.

Even when the paint film thickness is determined essentially via the upstream pressure, the bombardment energy and the bombardment frequency, the distance between the paint droplets when they strike the application surface also determines the thickness of the particular paint film, and is preferably somewhat smaller than the diameter of the paint droplets when they strike the wall. An overlap of approximately 20% is expedient. Given a particular sequence of bombardment which is matched to the traversing rate along the application surface, the result is a coating of the application surface using paint droplets without overlap, and, in fact, essentially only with the aid of a controlled metering of paint.

It may also be expedient to adjust—or to make adjustable—the working distance to the application surface as a function of the droplet size, the droplet speed, the paint consistency, and/or other parameters, such as the viscosity of the paint in particular, and to possibly also vary this working distance in a controlled manner during the working operation.

In particular, it is also possible to monitor the application surface and/or the paint film that forms on the application surface using sensors, it also being possible to use contrast and/or color sensors for the monitoring task in order to detect specified paint application boundaries, and to limit the bombardment with paint droplets to appropriately delimited regions.

To carry out the method according to the present invention, work is preferably carried out using a device as described in claim 6, which includes paint nozzles which are held at a specified distance away from the application surface, are pointed toward the application surface, are distributed across the application surface, are controlled in a cyclic manner, and which eject the paint in droplets—via the application of pressure—against the application surface, thereby applying the paint in droplets to the application surface.

A device of this type may be very compact in design, thereby enabling the device to also be used, in particular, as a hand-held device with a closed design, and which includes the paint application nozzles and a reservoir for the paint to be applied, the control and pump devices which enable the droplets to be ejected from the paint application nozzles in a specified cycle, and possibly including the sensor-based monitoring devices which are expedient for the control and monitoring of a uniform paint application. The device according to the present invention may also be designed as a cordless hand-held device, it may be used in conjunction with peripheral devices, or it may be mains-operated. For this purpose, a connection to a service station may also be provided, for the supply of paint and power, it being possible to also associate the supplying of paint with a preparation and/or filtering of paint.

The paint application nozzles are preferably situated in the base zone of the device housing; the paint application nozzles are advantageously situated such that they extend transversely to the working direction, in a row.

The particular nozzle rows are expediently located in the rear—relative to the feed direction of the paint application—region near the edge of the base zone of the device, thereby making it possible to attain, using simple means, a guidance of the device which is supported on the application surface without impairing the paint film that has been applied.

With regard for applying paint to the application surface in droplet form, it is expedient to provide only one row of paint application nozzles, the distance between the paint application nozzles corresponding approximately to the dimension of the diameter of the droplets, but preferably being greater than the droplet diameter, and amounting to approximately 1.5-fold the diameter of the droplets. The configuration of a plurality of nozzle rows—the nozzles being controlled and/or supplied in a common, group-wise or separate manner—also falls within the scope of the present invention, it being preferably provided in general that the nozzles are equidistant from one another.

The guidance of the device a specified distance away from the paint application surface may take place using rollers which are located on the base side of the device. A guiding device of this type may also be designed such that the distance to the application surface may be adjusted, and it may be changed during operation depending on the parameter.

A row arrangement of the paint application nozzles on the base side and close to the edge of the housing proves expedient for applying paint using lateral guidance devices, in particular rollers, when there is a contour next to projections such as door frames or the like, thereby at least largely rendering extra taping and/or covering work unnecessary.

It is also expedient to position the nozzle row which is close to the edge with a slight slant toward the outside relative to the base surface, and, in fact, in the rear—relative to the working direction—region of the base zone or the housing assigned to the device, thereby making it possible for the paint application to also continue at projections without overlap.

Using the sensor system which is provided according to the present invention, it is possible to determine when projections or the like are being approached, i.e. paint boundaries or boundary lines for a paint application, and to switch the paint application nozzles on or off. The variability of the device in being adapted to the needs of the particular working circumstances may also be expanded, in conjunction, in particular, with the controlled shut-off capability of the paint application nozzles by also assigning a further nozzle row to at least one of the transverse sides of the device, thereby making it possible for paint to be applied using a transverse side of this type adjacent to projections or the like, e.g. door frames.

The sensor-based detection of the paint application may also be used, according to the present invention, to monitor the paint application in a targeted manner, to signal when individual nozzles fail, and possibly to perform the paint application in a targeted manner at points known to have been missed, in the sense of making improvements during the actual working process, and possibly subsequently as well.

With regard for work of this type in particular, but also in general, it may be expedient to provide—for the nozzles which are situated in rows—an alternating offset transversely to the direction of extension of the particular nozzle row, or to design the nozzle row in a zig-zag shape. It may also be expedient within the scope of the present invention, in particular with regard for improvement work or the like, to provide—next to a nozzle row which is located close to the edge and extends transversely to the working direction—one or several additional nozzle rows, and to offset the nozzles relative to each other accordingly.

Further advantages and expedient embodiments are depicted in the claims, the description of the figures, and the drawing.

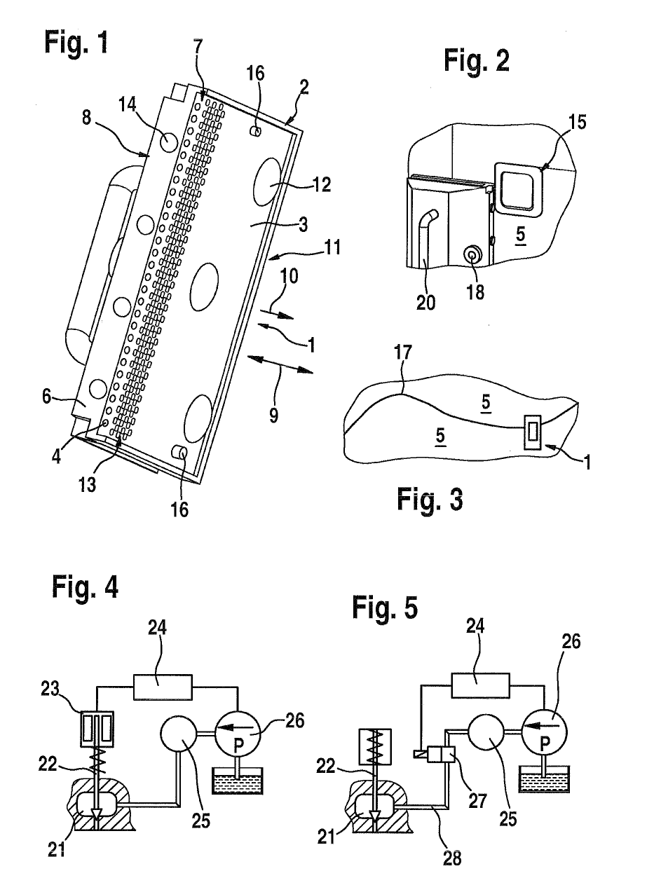

FIG. 1 shows a bottom-side, perspective view of a device according to the present invention,

FIG. 2 shows a partial depiction of the device in FIG. 1, in a top view; the illustration shows paint application along a projection on a wall side, which is a wall switch in this case,

FIG. 3 shows a schematic depiction of working with the device according to the present invention along a boundary line which extends between paint fields of different paint applications, and which extends along the paint application in one of the paint fields, and

FIGS. 4 and 5 show schematic depictions of a nozzle and the devices assigned thereto which ensure that paint is applied in a cyclic manner.

FIG. 1 shows a device 1 according to the present invention for applying liquid media in a coating manner, in particular for applying paint onto application surfaces which are moved over using device 1. In one embodiment, device 1 is depicted schematically as a hand-held working machine which may be used autonomously, and which includes a housing 2 with a base zone 3. Nozzle openings 4 are situated in base zone 3, and they are pointed toward particular application surface, which is labeled with reference numeral 5 in FIG. 3.

In the embodiment which shows a preferred design, device 1 is located along an edge 6 of housing 2 which is rectangular as viewed on the base side, and is shown—for simplicity—as points in a row. Nozzle openings 4 are also shown as a nozzle row 7 in the embodiment.

In the embodiment shown, nozzle openings 4 in row 7 are situated flush along longitudinal side 8 of housing 2 which is rectangular as viewed on the base side, longitudinal side 8 being situated transversely to moving direction 9 in which device 1 is typically moved when applying paint to an application surface 5. When paint is applied in this manner, device 1 is moved in the direction of arrow 10, so that nozzle row 7 is adjacent to rearward longitudinal side 8 of housing 9, relative to the working direction of the paint application (arrow 10). Device 1 may also be moved in other directions.

Spacers 12 are located in base zone 3 between nozzle row 7 and front—relative to the working direction indicated by arrow 10—longitudinal side 11, which are preferably formed by rolling elements which are supported in base zone 3, in particular spherical rolling elements. A distribution across base zone 3 as shown has proven advantageous for spacers 12, thereby making it possible, as a type of three-legged support, as shown, to guide device 1 across application surface 5 in a stable manner.

Base zone 3 is preferably enclosed all the way around by the edge of housing 2 with a slight overhang in the direction of paint application surface 5; regardless of this overhang, spacers 12 ensure that device 1 may move freely along paint application surface 5. An edge enclosure of this type may also be used advantageously as spray protection, and to delimit base zone 3 from the surroundings in order to prevent impairments to the paint application from drafts or the like.

Nozzle row 7 is shown with nozzle openings 4 which are aligned one after the other. Nozzle openings 4 in a nozzle row may also be situated with a slight offset to one another relative to moving direction 9, e.g. a zig-zagged offset in particular. At least two nozzle rows situated in a row formation are therefore present, which are situated transversely to moving direction 9 relative to their nozzle openings 4, i.e. being situated in gaps.

An arrangement of this type is symbolized using point strips 13, a design of this type also proving expedient—possibly in addition to a nozzle row 7—for attaining a largely sheet-type paint application using fine nozzles with paint droplets of small size.

FIG. 1 also shows that, in particular, spherical spacers 14 may be advantageously provided on the edge side along rearward longitudinal side 8. Spacers 14 make it possible, as shown, e.g. in FIG. 2, to move device 1 directly next to projections on paint application surface 5, or to guide it alongside to projections of this type, a projection of this type being illustrated in FIG. 2 as a switchplate 15.

In order to apply paint directly adjacent to projections of this type, e.g. switchplate 15, walls which extend transversely to paint application surface 5, or the like, nozzle openings located in nozzle row 7 are preferably slanted toward base zone 3, and, in fact, in the direction toward adjacent edge 6 of longitudinal side 8.

FIG. 1 also shows, schematically, that the device is preferably equipped with sensors 16, e.g. in base zone 3 or in the region of the housing edge which abuts base zone 3, in order attain a sharply delineated application of paint on different-colored regions or fields of the paint application surface. These may be delimited from one another via specified markings which are detected by sensors 16, or the boundary line of a surface which has already been painted may be detected using sensors 16, in order to apply paint, e.g. of a different color, to a region adjacent thereto without gaps. This is illustrated in FIG. 3 by boundary line 17 between different regions of paint application surface 5. Device 1 is shown overlapping boundary line 17.

With regard for work of this type, it has also proven advantageous to trigger or shut off the particular nozzles with consideration for the circumstances which are detected via sensors 16, it being possible to switch them on or off individually or in groups.

FIGS. 1 through 3 show that device 1—for the autonomous application which is aimed for—accommodates the devices used to apply paint preferably such that they are enclosed in a housing, a paint filling connector 18 being provided on the housing for supplying an integrated paint reservoir. It may also be expedient to integrate a filter and/or stirring device in order to prevent the paint from clumping and the nozzles from becoming clogged, in particular when viscous dispersion paints are used. Device 1 is also provided with a handle 20.

It is within the scope of the embodiment shown to also provide further edge sides of housing 2 with spacers, analogous to spacers 14. The scope of the present invention also includes other configurations of the nozzle rows, it being possible to attain working directions that differ from that shown in the embodiment by switching the particular nozzles on or off, and which expand the possible uses of the device according to the present invention. For all of these embodiments it is also advantageous in particular—by detecting the working situation accordingly using the sensor system—to perform work directly up to projections or the like without worrying about contaminating them, thereby eliminating the need to apply tape or the like, and ensuring that work may be performed quickly and efficiently while largely preventing the need to perform any work beyond the actual application of paint.

Via nozzle openings 4 and the nozzles assigned thereto, paint is applied using the device according to the present invention in droplet form to paint application surface 5, which is quasi bombarded, and the droplets which are applied to the paint application surface flow into one another in a “bursting” manner, thereby resulting in a closed paint film. This requires a cyclic ejection of paint droplets via nozzles and an appropriate level of pressure for ejecting the paint droplets.

FIGS. 4 and 5 show devices—in a schematicized view—for applying paint, which may be integrated in the device.

FIG. 4 shows a schematic illustration of a nozzle opening 4 which extends out of a nozzle chamber 21 and is penetrated by a nozzle needle 22 which controls nozzle opening 4, nozzle needle 22 being displaceable in a reciprocating direction via an actuator 23, e.g. a piezoactuator or the like. Actuator 23 is controlled via a control device 24, and nozzle chamber 21 is connected to a pressure reservoir 25, to which a pump 26, for example, is assigned in order to build up the necessary pressure, and which is used to convey the paint to be applied into pressure reservoir 25.

When nozzle needle 22 is lifted via actuator 23 out of its closed position shown, in which it closes nozzle opening 4, and against the force of a spring 34, paint exits in a time-dependent manner. When the opening time is short, the result is a paint droplet which is ejected in the direction of the paint application surface in accordance with the pressure which is present in pressure reservoir 25. A clock frequency which is expedient for this application is approximately 100 paint droplets per second.

Given a design of this type, it is possible to trigger the nozzles individually, or in groups when the appropriate actuators are used, it being possible to use only one actuator 23 to actuate several nozzle needles.

In embodiments of the type shown in FIGS. 4 and 5, it is preferable to work with one pressure reservoir 25, which may also be used as the paint reservoir. As shown in FIG. 5, a device is provided in which particular nozzle opening 4 is controlled via a nozzle needle 22 which is displaceable between a closed position and an opened position depending on the pressure that is present in nozzle chamber 21. For this purpose, nozzle chamber 21 may be connected to the cylinder chamber of a pump cylinder, the piston of which is acted upon using an actuator. FIG. 5 shows a pressure reservoir 25 which is charged using a pump 26, pressure reservoir 25 being connected via a line with nozzle chamber 21, a valve 27 being located in the line connection. A control device 24 is provided, via which valve 24 is controlled. In this embodiment as well, the nozzles may be controlled individually or in groups, simply by locating a shutoff valve 27 in particular connection 28 to nozzle chamber 21.

The devices which are shown represent possible embodiments, and other types of devices may also be utilized, e.g. of the types known from metering systems.

What is claimed is:

1. A method for applying liquid paint to an application surface, in particular for applying dispersion paint onto walls,
wherein
the paint is shot drop-wise onto the application surface from a specified distance, and a uniform paint film is formed by the drops flowing into one another on the application surface.

2. The method as recited in claim 1,
wherein
the paint drops are shot onto the application surface in an overlapping manner.

3. The method as recited in claim 1,
wherein
the distance between the paint drops that exists when they strike the application surface is in the range of the diameter of the paint drops, and, in particular, is smaller than the diameter of the paint drops is when they strike the application surface.

4. The method as recited in claim 1,
wherein
the distance from which the paint drops are shot against the application surface is held constant, as the working distance.

5. The method as recited in claim 1,
wherein
the working distance is adjusted as a function of the drop size, the drop speed, the upstream pressure setting, the clock frequency, and/or the paint consistency, in particular the viscosity of the paint.

6. The method as recited in claim 1,
wherein
the traversing rate along the application surface and the clock frequency with which the paint drops are shot are coordinated with one another.

7. The method as recited in claim 6,
wherein
the traversing rate along the application surface is detected using sensors and is used as a controlled variable.

8. A device for applying liquid paint to an application surface, in particular for applying dispersion paint to wall surfaces, in particular for carrying out the method as recited in claim 1,
wherein
the device (1) includes paint application nozzles which include nozzle openings (4) which are held a specified distance away from the application surface (5), are pointed toward the application surface (5), are distributed across the application surface, and which are controlled in a cyclic manner, and eject the paint in droplets—via the application of pressure—onto the application surface (5), thereby applying the paint in droplets to the application surface (5).

9. The device as recited in claim 8,
wherein
the device (1) includes a housing (2) which includes a base zone (3) facing the application surface (5), in which the paint application nozzles are located.

10. The device as recited in claim 8,
wherein
the paint application nozzles are positioned in a row which extends transversely to the working direction (10) of the device (1).

11. The device as recited in claim 10,
wherein
the device (1) includes at least one nozzle row (7) which is located transversely to the working direction (10), on the housing side, and close to the edge.

12. The device as recited in claim 11,
wherein
the paint application nozzles of the nozzle row (7) which is positioned transversely to the working direction (10) and close to the edge are directed toward the application surface in the working direction (10), at a slant relative to the application surface (5).

13. The device as recited in claim 8,
wherein
the distance between the paint application nozzles corresponds approximately to the magnitude of the diameter of the droplets.

14. The device as recited in claim 8,
wherein
the distance between the paint application nozzles is in the range of 1.5-fold the diameter of the droplets.

15. The device as recited in claim 8,
wherein
the device (1) is held a specified distance away from the application surface (5) by a guide device.

16. The device as recited in claim 15,
wherein
the guide device is formed by spacers (12), in particular spherical rolling bodies, which are located in the base zone (3) of the device (1) and are supported against the wall surface.

17. The device as recited in claim 8,
wherein
an edge mounting is provided, at least in sections, on the base side and close to the edge of the housing (2), the distance of which to the application surface (5) is less than the specified working distance of the paint application nozzles from the application surface (5).

18. The device as recited in claim 8,
wherein
the device (1) is provided with lateral spacers (14), in particular rollers, in the region of the base zone (3), on the edge side, opposite the working direction, and in front of the nozzle row.
